(19) United States
(12) Patent Application Publication
(10) Pub. No.: US 2011/0012072 A1
(43) Pub. Date: Jan. 20, 2011

(54) Use of Hydrophobic Solvent-Based Pigment Preparations in Electronic Displays

(75) Inventors: Lars Luecke, Hofheim am Taunus (DE); Jens Reichwagen, Wiesbaden (DE); Mike Husbands, West Yorkshire (GB); Sarup Panesar, West Yorkshire (GB)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/811,669

(22) PCT Filed: Dec. 2, 2008
(86) PCT No.: PCT/EP08/10186

§ 371 Date: Sep. 17, 2010

(30) Foreign Application Priority Data
Jan. 10, 2008 (DE) 10 2008 003 829.6

(51) Int. Cl. G02F 1/361

(52) U.S. Cl. 252/582

(57) ABSTRACT

The invention relates to the use of a pigment preparation as a dye for producing a colored optical image in an electronic display, said pigment preparation containing (A) at least one organic and/or inorganic pigment, (B) at least one solvent-soluble or solvent-dispersible polymeric dispersant, (C) at least one aldehyde resin or ketone resin, (D) optionally further additives common for producing solvent-containing pigment preparations, and (E) at least one hydrophobic solvent.

The present invention relates to the use of hydrophobic, solvent-based pigment preparations and pigment dispersions for coloring electronic displays, more particularly as colorants for generating a colored optical image, both for additive and for subtractive color generation, more particularly of a transmissive optical image (e.g., display technologies functioning on the color filter principle) or reflective optical image (e.g., electrophoretic display or display functioning on the principle of electrowetting).

One description of the principle of electrowetting is given in WO 2005/098524 A1. It involves two switchable states which depend on the wettability of a polymeric solid that has a hydrophobic surface with a hydrophobic liquid. The polymeric hydrophobic solid preferably has a white color. The hydrophobic liquid and the solid are additionally surrounded by a hydrophilic liquid (e.g., water). An applied voltage between the hydrophilic liquid and the hydrophobic solid generates a voltage difference and, consequently, a change in the surface tension of the hydrophobic liquid; it evades the applied potential. As a result, the hydrophilic liquid no longer completely covers the pixel base, which is preferably white, but instead only covers a fraction thereof. This change in surface tension at maximum applied voltage and no applied voltage can be perceived by a viewer as an “on” or “off” state of the pixel. The optical impression of the pixel is white in the “on” state and colored in the “off” state.

The electrowetting technology in displays has a number of advantages over other display technologies: low energy consumption and rapid switchover times between pixel states, which are important for video applications. Furthermore, the pixels in the display can represent different colors, since the color of a pixel is ensured by a dye which is dissolved in the hydrophobic liquid. The dye must be insoluble in the hydrophilic liquid. Accordingly it is possible to realize a transmissive display based on red, green, and blue (RGB) plus black, or a reflective display based on cyan, magenta, and yellow (CMY) plus black.

The change in surface tension of the hydrophobic liquid is proportional to the voltage applied. Accordingly, depending on the voltage, different gray stages can be represented in the pixel, and a high-quality image can be generated in the display.

Apart from for displays, electrowetting can also be employed in optical filters, adaptive lenses, and lab-on-a-chip applications.

For coloring in the abovementioned application in displays, exclusively solvent-based, hydrophobic dye solutions have been described. Dyes in solutions, however, in comparison to pigments which are present in crystalline form in the application medium, intrinsically possess a lower lightfastness. Furthermore, before display application, these dye solutions must undergo costly and inconvenient degassing, in order to exclude traces of oxygen in the hydrophobic liquid. Via oxidative degradation processes, oxygen may destroy, fade, and distort the shade of dyes. When pigments are used in the hydrophobic medium, the cost and inconvenience of the degassing to achieve a greater lightfastness is removed.

The technology of electrophoretic displays, as described in WO 0167170, for example, employs white pigment particles which are electrically charged, can be moved via an applied voltage, and are therefore controllable, these particles being present in dispersion in a hydrophobic medium which is colored with a dye. When the white pigment particles are transported, by means of an applied voltage, to the surface of the pixel, the pixel appears to the viewer to be white. Where the white pigment particles are transported, with the aid of an applied voltage, to the base of the pixel, the pixel appears to the viewer in the color with which the hydrophobic medium is colored by means of the dye. Here again, as described above, there is the intrinsic disadvantage that dyes are not as lightfast as particulate pigments.

It was an object of the present invention, therefore, to provide a pigment preparation which is suitable for application in the abovementioned electronic display systems.

In order to ensure the switchability of the optical “on” and “off” states of the pixels in a display, the pigment preparation ought to have a high sedimentation stability in the hydrophobic medium and a viscosity which allows switching processes. The sedimentation stability and viscosity ought to be very largely independent of the voltage applied.

In order to achieve high color strengths, precisely defined shades, and high sedimentation stability with low viscosity, the pigment particles must be very effectively stabilized in the dispersion by dispersants and additives. Neither during the dispersing operation nor during the storage, over a prolonged time period, and in the subsequent application, should there be flocculation phenomena, instances of reagglomeration or instances of sedimentation. Such phenomena would otherwise lead to changes in the viscosity of the preparation and, possibly, to changes in shade and losses of color strength, opacity, gloss, homogeneity, brilliance, and also to poorly reproducible shades. Furthermore, specifically in the context of application in transmissive and reflective displays, phenomena of this kind result in the failure of switchable states, particularly the switching on and off of colored visual impressions (color on/off), which enable color representation by the pixels in a display.

The pigment preparations ought as far as possible to be compatible with a wide number of hydrophobic application media, and for this reason the dispersants and additives must be compatible with such systems.

Surprisingly it has been found that the pigment preparations described below exhibit high stability toward sedimentation, outstanding flow capacities, and sufficient stability in an electrical field in the context of a display application, and therefore achieve the object identified above.

The present invention provides for the use of a pigment preparation comprising
(A) at least one organic and/or inorganic pigment,
(B) at least one solvent-soluble or solvent-dispersible polymeric dispersant,
(C) at least one aldehyde resin or ketone resin,
(D) if desired, other adjuvants customary for producing solvent-containing pigment preparations, and
(E) at least one hydrophobic solvent
   as a colorant for generating a colored optical image in an electronic display.

The pigment preparations used in accordance with the invention are suitable both for additive and for subtractive color generation in a display.

Examples of additive color generation are the transmissive display technologies, e.g., those operating on the color filter principle.

Examples of subtractive color generation are the reflective display technologies, e.g., those operating on the electrophoretic principle or on the principle of electrowetting.

Preferred pigment preparations for the purposes of the inventive application contain
(A) 0.1% to 80% by weight, preferably 1% to 40% by weight, of at least one organic and/or inorganic pigment,
(B) 0.1% to 30% by weight, preferably 1% to 20% by weight, of at least one solvent-soluble or solvent-dispersible polymeric dispersant,
(C) 0.1% to 80% by weight, preferably 0.1% to 50% by weight, of an aldehyde resin or ketone resin,
(D) 0% to 50% by weight, preferably 0.1% to 20% by weight, of further additives customary for producing solvent-containing pigment preparations, and
(E) 5% to 99% by weight, preferably 40% to 95% by weight, of hydrophobic solvent,
   based in each case on the total weight of the pigment preparation.

Component (A) is a finely divided organic or inorganic pigment or a mixture of different organic and/or inorganic pigments. Component (A) may also be a dye which is insoluble in the solvents of the inventive application and in them has pigment character.

Organic pigments contemplated include monoazo, disazo, laked azo, β-naphthol, naphthol AS, benzimidazolone, disazo condensation, azo metal complex pigments, and polycyclic pigments such as phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, and diketopyrrolopyrrole pigments or carbon blacks.

As an example selection of particularly preferred organic pigments, mention may be made here of carbon black pigments, such as gas blacks or furnace blacks, for example; monoazo and disazo pigments, more particularly the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and naphthol AS pigments, more particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo pigments and metal complex pigments, more particularly the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, more particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, more particularly the Colour Index Pigments Pigment Yellow 139 or Pigment Yellow 173; phthalocyanine pigments, more particularly the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone, and thioindigo pigments, more particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, more particularly the Colour Index pigments Pigment Red 169, Pigment Blue 56 or Pigment Blue 61; diketopyrrolopyrrole pigments, more particularly the Colour Index pigments Pigment Red 254, Pigment Red 255, Pigment Red 264, Pigment Red 270, Pigment Red 272, Pigment Orange 71, Pigment Orange 73, and Pigment Orange 81.

Examples of suitable inorganic pigments are titanium dioxides, zinc sulfides, zinc oxides, iron oxides, manganese iron oxides, chromium oxides, ultramarine, nickel or chromium antimony titanium oxides, cobalt oxides, mixed oxides of cobalt and of aluminum, rutile mixed phase pigments, rare earth sulfides, bismuth vanadates, and extender pigments.

The organic pigment may be combined with carbon black and/or titanium dioxide.

Suitable dyes for the purposes of the present invention may belong to the group of the polymer dyes, acid dyes, reactive dyes, basic dyes, solvent dyes, mordants, direct dyes, disperse dyes, fluorescent dyes, sulfur dyes, vat dyes, and metal complexes. Also suitable are laked dyes such as Ca, Mg, and Al lakes of dyes containing sulfonic and/or carboxylic acid groups.

Component (B) comprises solvent-soluble or solvent-dispersible polymeric dispersants which possess a molar mass of 500 to 500,000 g/mol, preferably of 1000 to 500,000 g/mol. These dispersants comprise preferably nonionic compounds, such as polyethylene oxides, polypropylene oxides, polyoxymethylenes, polytrimethylene oxides, polyamides, preferably Solsperse® 11200 from Lubrizol Inc., polyarylamides, and copolymers thereof; polyethylenimines, polyvinyl methyl ethers, polymethacrylates, polymethacrylamides, poly-N,N-dimethylacrylamides, poly-N-isopropylacrylamides, poly-N-acryloylglycinamides, poly-N-methacryloylglycinamides, polyvinyl alcohols, polyvinyl acetates, polyvinyl alcohols, polyvinylpyrrolidones, polyvinyloxazolidones, polyvinylmethyloxazolidones, and copolymers thereof; reaction products of alkylene oxides with fatty alcohols, fatty amines, fatty acids, phenols, alkylphenols, arylalkylphenols, such as styrene-phenol condensates, which are obtained by addition reaction of unsubstituted or substituted styrenes with unsubstituted or substituted phenols and reaction with ethylene oxide and/or propylene oxide, and also their ionically modified derivatives, in the form, for example, of sulfonic, sulfuric, and phosphoric esters, and also carboxamides and natural resins. With further preference the dispersant of the type Solsperse® 16000 from Lubrizol Inc. is used.

Serving as component (C), preferably, are urea-aldehyde resins or aldehyde-ketone resins—the aldehydes comprise preferably C₁-C₄ aldehydes, more preferably formaldehyde, or aliphatic dialdehydes, preferably glyoxal. Resins for the purposes of the present invention are available commercially, as for example under the trade name Laropal® (BASF AG), preferably cyclohexanone polycondensates of the Laropal K80 type, or Synthetic Resin TC® (Evonik Industries). These resins are composed of a low molecular mass condensation product of urea with an aliphatic aldehyde, or of an aliphatic aldehyde with a ketone. The softening point of these resins lies between 70 and 110° C.

As component (D) use is made, for example, of cationic, anionic, amphoteric or nonionic, preferably nonionic, compounds, which promote pigment wetting (wetting agents) and which are different from components (B) and (C). Also employed are thickeners, preservatives, viscosity stabilizers, grinding assistants, fillers, and retention aids.

Further customary adjuvants may be antisettling agents, light stabilizers, antioxidants, biocides, degassers/defoamers, antifoam agents, anticaking agents, and also additives which favorably influence the viscosity and rheology.

Agents contemplated for regulating the viscosity include, for example, polyvinyl alcohol and cellulose derivatives. Solvent-soluble natural or synthetic resins and also polymers as film formers and/or binders for increasing adhesive strength and abrasion resistance are likewise contemplated. pH regulators employed are organic or inorganic bases and acids. Preferred organic bases are amines, such as fatty amines, ethanolamine, diethanolamine, triethanolamine, N,N-dimethylethanolamine, diisopropylamine, triethylamine, diisopropylethylamine, aminomethylpropanol or dimethylaminomethylpropanol. Preferred inorganic bases are sodium, potassium or lithium hydroxide or ammonia.

Other customary adjuvants may also be fats and oils of vegetable and animal origin, examples being bovine tallow, palm kernel fat, coconut fat, rapeseed oil, sunflower oil, linseed oil, palm oil, soya oil, peanut oil, and whale oil, cottonseed oil, corn oil, poppy oil, olive oil, castor oil, colza oil, safflower oil, soybean oil, sunflower oil, herring oil, sardine oil. The saturated and unsaturated higher fatty acids are also common additives, examples being palmitic acid, cyprylic acid, capric acid, myristic acid, lauric acid, stearic acid, oleic acid, linoleic acid, linolenic acid, caproic acid, cyprylic acid, arachidic acid, behenic acid, palmitoleic acid, gadoleic acid, erucic acid, and ricinoleic acid, and also salts thereof.

The pigment preparations of the invention are produced using a hydrophobic solvent, component (E). Hydrophobic solvents for the purposes of the present invention have a Reichardt number E_{T}(30) of more than 27 kcal/mol and less than 50 kcal/mol. The Reichardt number is defined in the following publications: C. Reichardt, Solvents and Solvent Effects: An Introduction, Organic Process Research & Development 2007, 11, 105-113 and C. Reichardt, Chem. Rev. 1994, 94, 2319-2358.

The hydrophobic solvents having a Reichardt number of more than 27 kcal/mol and less than 50 kcal/mol comprise straight-chain and/or branched or cyclic C₄-C₃₀ alkanes, preferably pentane, hexane, heptane, octane, nonane, decane, undecane, dodecane, cyclopentane, cyclohexane, cycloheptane, cyclooctane, and methylcyclohexane, more preferably decane and undecane, or a mixture of these in any desired proportion;

straight-chain and/or branched and/or cyclic C₁-C₃₀ haloalkanes, preferably dichloromethane, chloroform, tetrachloromethane, dichloroethane, trichloroethane, tetrachloroethane, chlorocyclohexane, and their position isomers;
C₆-C₂₂ aromatics, preferably benzene, toluene, xylene, mesitylene, or a mixture of these in any desired proportion; or hydrogenated C₁₀-C₂₂ aromatics, preferably tetralin, cis- and trans-decalin, or a mixture of these in any desired proportion, more preferably cis- and trans-decalin;
halogenated C₆-C₂₂ aromatics, preferably chloro- and fluorobenzene, dichloro- or difluorobenzene, trichloro- or trifluorobenzene, chloro- or fluoronaphthalene, and their position isomers;
straight-chain and/or branched and/or cyclic C₄-C₂₂ alcohols, preferably butanol, pentanol, hexanol, heptanol, octanol, nonanol, decanol, undecanol, dodecanol, benzyl alcohol, phenylethanol, cyclopentanol, cyclohexanol, cycloheptanol or cyclooctanol, and their position isomers;
straight-chain and/or branched and/or cyclic ethers, preferably diethyl ether, dipropyl ether, tert-butyl methyl ether, tert-amyl methyl ether, tert-amyl ethyl ether, dimethoxyethane, diethoxyethane, diglyme, triglyme, furan, tetrahydrofuran, tetrahydromethylfuran, dioxolane, tetrahydrothiophene, tetrahydropyran, dioxane, methoxybenzene, methylthiobenzene, and ethoxybenzene, and their position isomers;
straight-chain and/or branched and/or cyclic ketones, preferably acetone, trichloroacetone, butanone, pentanone, hexanone, heptanone, octanone, nonanone, cyclopentanone, cyclohexanone, acetophenone, acetylacetone and their position isomers;
straight-chain and/or branched and/or cyclic nitroalkanes, preferably nitromethane, nitroethane, nitrocyclohexane, and their position isomers;
C₆-C₂₂ nitroaromatics, preferably nitrobenzene;
straight-chain and/or branched and/or cyclic amines, preferably tert-butylamine, diaminoethane, diethylamine, triethylamine, tributylamine, pyrrolidine, piperidine, morpholine, N-methylaniline, and N,N-dimethylaniline, and their position isomers; or a mixture of the abovementioned solvents in any desired proportion.

Particularly preferred hydrophobic solvents are decane, decalin, tetralin or a mixture thereof, or solvents which comprise those stated as a main constituent.

The pigment preparations used in accordance with the invention can be produced by dispersing component (A) in the form of powder, granules or aqueous presscake, preferably predried presscakes, in the presence of the hydrophobic solvent (E) and also of component (B), then admixing, where used, further hydrophobic solvent (E), and also (C) and, where used, (D), and adjusting the resulting pigment dispersion with hydrophobic solvent (E) to the desired concentration. Preferably, components (B), (C) and, where used, (D) are first mixed and homogenized, and then component (A) is stirred into the initial mixture, the pigment being pasted and predispersed. Depending on the grain harshness of the pigments used, the next step may be fine dispersion or fine division, with cooling, by means of a grinding or dispersing assembly. For that purpose it is possible to use stirring mechanisms, dissolvers (sawtooth stirrers), rotor-stator mills, ball mills, ball mills with stirring mechanisms, such as sand mills and bead mills, high-speed mixers, kneading apparatus, roil mills or high-performance bead mills. The fine dispersion or grinding of the pigments takes place until the desired particle size distribution is reached, and can be carried out at temperatures in the range from 0 to 100° C., advantageously at a temperature between 10 and 70° C., preferably at 20 to 60° C. Following the fine dispersing operation, the pigment preparation may be diluted further with hydrophobic solvent (E).

The hydrophobic pigment preparations used in accordance with the invention possess high color strengths and defined shades, with low viscosity, which presupposes effective stabilization of the pigment particles in the dispersion. In the course of the dispersing operation and also in the course of storage, flocculation phenomena, instances of reagglomeration or instances of sedimentation occur only very slightly or not at all. A high storage stability is indicated, for example, by the observation of absence of sedimentation within a time period of three weeks at room temperature.

The invention also provides pigment preparations comprising
(A) 0.1% to 80% by weight, preferably 1% to 40% by weight, of at least one organic and/or inorganic pigment,
(B) 0.1% to 30% by weight, preferably 1% to 20% by weight, of at least one solvent-soluble or solvent-dispersible polymeric dispersant,
(C) 0.1% to 80% by weight, preferably 1% to 50% by weight, of an aldehyde resin or ketone resin, more particularly of a condensation product of urea with an aliphatic aldehyde, or of a condensation product of an aliphatic aldehyde with a ketone,
(D) 0% to 50% by weight, preferably 0.1% to 20% by weight, of further additives customary for producing solvent-containing pigment preparations, and
(E) 5% to 99% by weight, preferably 40% to 95% by weight, of decane, tetralin, decalin or a mixture thereof,
   based in each case on the total weight of the pigment preparation.

Besides the applications described above, the pigment preparations of the invention are also suitable for coloring toners which are the basis of the electrophoretic technology described in EP 1855154. In this context, the electrophoretically mobile toners are moved not by a liquid medium but rather by a gaseous medium, with the aid of an applied voltage.

Besides the applications described above, the pigment preparations of the invention are also suitable as colorants for color filters, for both additive and subtractive color generation, as for example in electrooptical systems such as television screens, LCDs (liquid crystal displays), charge coupled devices, plasma displays or electroluminescent displays, which in turn may be active (twisted nematic) or passive (supertwisted nematic) ferroelectric displays or light-emitting diodes; and also as colorants for the BiNem® technology, which is distinguished by nematic, twistable liquid-crystalline and bistable states, i.e., states which are stable without external supply of energy.

The pigment preparations of the invention can also be used as colorants for solvent-based inkjet inks. Solvents contemplated include, for example, esters, ketones, acetates, alcohols, amides, and ethers. Preferred are N-methyl-pyrrolidone, cyclohexanone, ethyl acetate, isobutyl acetate, methyl ethyl ketone, methyl isobutyl ketone, n-butyl acetate, propyl acetate, (1-methoxy-2-propyl) acetate, 2-hydroxybutyl propanoate, 2-butoxyethanol acetate, 2-butoxyethynol, 1-methoxy-2-propanol, and 2-methyl-2,4-pentanediol.

### EXAMPLES

### Production of a Pigment Preparation:

The pigment, in the form alternatively of powder, granules or presscake, was pasted up together with the dispersants and the other adjuvants in the appropriate solvent, and then homogenized and predispersed with a dissolver (e.g., from VMA-Getzmann GmbH, type AE3-M1) or with another suitable apparatus. The subsequent fine dispersion took place by means of a bead mill (e.g., from Eiger, type Mini Motormill 250 Mk II M2501100 VSE-EXD) or else with another suitable dispersing assembly, the grinding being carried out with siliquarzite beads or zirconium mixed oxide beads with a size d of 1 mm, with cooling, until the desired color strength and coloristic properties were obtained. Thereafter, the dispersion was adjusted to the desired final pigment concentration with the corresponding solvent (E) or, if necessary, with a solution of components (B), (C), and, where used, (D) in the solvent (E), and the grinding media were separated off, and the pigment preparation was isolated.

The pigment preparations described in the examples below were produced by the process described above, the following constituents being used in the amounts stated in such a way as to produce 100 parts of the particular pigment preparation. Parts are parts by weight.

### Example 1

33 parts C.I. Pigment Violet 19 (component A),
13 parts Solsperse® 11200 (component B),
19 parts Laropal® K80 (BASF AG, component C),
Remainder decalin (component E)

The pigment preparation has a high color strength and is stable to flocculation. The pigment preparation possesses very good rheological properties, and is found to be readily flowable and storage-stable. The viscosity following production is 414 mPa·s.

### Dilution Examples 1 a-d

The pigment preparation produced in example 1 was admixed with an amount of a 50% solution of Laropal® K80 in decalin that made the pigment content 5 parts (example 1a), 10 parts (example 1b), 15 parts (example 1c) or 20 parts (example 1d) of the pigment preparation of example 1. The viscosities of examples 1a-d are summarized in table 1. The pigment preparations possess very good rheological properties, and are found to be readily flowable and storage-stable.

### Dilution Examples 1e-h

The pigment preparation produced in example 1 was admixed with an amount of decalin such as to make the pigment content 5 parts (example 1 e), 10 parts (example 1f), 15 parts (example 1g) or 20 parts (example 1h) of the pigment preparation of example 1. The viscosities of examples 1e-h are summarized in table 1.

### Comparative example

20 parts C.I. Pigment Violet 19 (component A),
15 parts Laropal® K80 (BASF AG, component C),
Remainder decalin (component E)

The pigment preparation has a high color strength, but is not stable to flocculation, The pigment preparation does not possess good rheological properties, since sedimentation occurred, and is therefore also not storage-stable.

### Example 2

33 parts C.I. Pigment Violet 19 (component A),
13 parts Solsperse® 16000 (Lubrizol, component B),
6 parts Laropal® K80 (BASF AG, component C),
Remainder decalin (component E)

The pigment preparation has a high color strength and is stable to flocculation. The pigment preparation possesses very good rheological properties, and is found to be moderately to readily flowable and storage-stable. The viscosity following production is 512 mPa·s.

### Example 3

33 parts C.I. Pigment Violet 19 (component A),
13 parts dispersant from WO 0234840, example 1 (component B),
19 parts Laropal® K80 (BASF AG, component C),
Remainder decalin (component E)

The pigment preparation has a high color strength and is stable to flocculation. The pigment preparation possesses very good rheological properties, and is found to be readily flowable and storage-stable. The viscosity following production is 426 mPa·s.

### Example 4

22 parts C.I. Pigment Black 7 (component A),
13 parts Solsperse® 16000 (Lubrizol, component B),
40 parts Laropal® K80 (BASF AG, component C),
Remainder decalin (component E)

The pigment preparation has a high color strength and is stable to flocculation.

The pigment preparation possesses very good rheological properties, and is found to be readily flowable and storage-stable. The viscosity following production is 124 mPa·s.

### Dilution examples 4a-c

The pigment preparation produced in example 4 was admixed with an amount of a 50% solution of Laropal® K80 in decalin that made the pigment content 5 parts (example 4a), 10 parts (example 4b), and 15 parts (example 4c) of the pigment preparation of example 4. The viscosities of examples 4a-c are summarized in table 1. The pigment preparations possess very good rheological properties, and are found to be readily flowable and storage-stable.

### Dilution examples 4d-f

The pigment preparation produced in example 4 was admixed with an amount of decalin such as to make the pigment content 5 parts (example 4d), 10 parts (example 4e), and 15 parts (example 4f) of the pigment preparation of example 4. The viscosities of examples 4d-f are summarized in table 1.

### Example 5a

22 parts C.I. Pigment Black 7 (component A),
13 parts Solsperse® 16000 (Lubrizol, component B),
40 parts Synthetic Resin TC® (Evonik Industries, component C),
Remainder decalin (component E)

The pigment preparation has a high color strength and is stable to flocculation. The pigment preparation possesses very good rheological properties, and is found to be readily flowable and storage-stable. The viscosity following production is 55 mPa·s.

### Example 5b

22 parts C.I. Pigment Black 7 (component A),
13 parts Solsperse® 16000 (Lubrizol, component B),
40 parts Synthetic Resin TO® (Evonik Industries, component C),
Remainder decane (component E)

The pigment preparation has a high color strength and is stable to flocculation. The pigment preparation possesses very good rheological properties, and is found to be readily flowable and storage-stable. The viscosity following production is 19 mPa·s.

### Viscosity of the Pigment Preparations:

The viscosity was determined using a cone/plate viscometer (Roto Visco 1) from

Haake at 20° C. (titanium cone: 60 mm, 1°), the parameter studied being the dependence of the viscosity on the shear rate in a range between 0 and 200 s⁻¹. The viscosities were measured at a shear rate of 60 s⁻¹.

For assessing the storage stability of the dispersions, the viscosity was measured directly after the production of the preparation, and also after three-week storage at room temperature (RT) and after storage in a controlled-climate chamber at <0° C.

The pigment preparations of the invention were studied qualitatively under a microscope for homogeneity. Dispersion is good when the dispersion under the microscope appears homogeneous, without discernible agglomerates and instances of phase separation, and when the filter test gives a short filtration time with no blockage of the filter.

### Filter Test:

200 ml of the pigment preparation were filtered at room temperature through a Sartorius glass-fiber filter (glass microfiber GMF 4, Ser. No. FT-3-1104-047) under reduced pressure. For all of the pigment preparations referred to in examples 1-5, the filtration time, in seconds, was ascertained. If the filter blocks in the course of filtration, i.e., filtrate is no longer collected, the quality objective is not attained.

The results of the viscosity measurements following production and after three weeks of storage at room temperature, the filtration time, the visual assessment of the pigment preparation, and the sedimentation, for examples 1 to 5, are given in table 1.

The pigment preparations, following drawdown onto specialty paper of type Renolit ML, were assessed visually in accordance with the following criteria, with indices from 1 to 4:

| | |
|---|---|
| Index 1 | Very fine, homogeneous distribution of the pigment preparation |
| | with high stability or very good color after printing in the |
| | drawdown |
| Index 2 | Fine, homogeneous distribution of the pigment preparation with |
| | good stability or good color after printing in the drawdown |
| Index 3 | Nonhomogeneous pigment preparation with visible particles, |
| | limited stability or unacceptable color after printing in the |
| | drawdown |
| Index 4 | Nonhomogeneous pigment preparation with particles which |
| | after a short time are visible to the naked eye, or |
| | nonhomogeneous color after printing in the drawdown, pigment |
| | particles visible on the paper after printing |

Optical assessment of the sedimentation, with indices from 1 to 5:

| | |
|---|---|
| Index 1 | Sedimentation absent or not perceptible |
| Index 2 | Very slight, barely perceptible sedimentation |
| Index 3 | Slight, perceptible sedimentation |
| Index 4 | Significant, readily perceptible sedimentation |
| Index 5 | Very strongly perceptible sedimentation |

TABLE 1
Pigment preparations

| Prepared | Viscosity | Viscosity | Filtration | Optical assessment | |
|---|---|---|---|---|---|
| according | mPa·s | mPa·s | time | after coating onto | Optical assessment |
| to | [sec⁻¹] | [sec⁻¹]^{#} | [sec] | Renolit ML paper | of sedimentation^{#} |
| Example 1 | 414 | 451 | 15 | 1 | 1 |
| Example 1a | 236 | 244 | 18 | 1 | 1 |
| Example 1b | 154 | 149 | 13 | 1 | 2 |
| Example 1c | 117 | 98 | 11 | 1 | 2 |
| Example 1d | 113 | 121 | 8 | 1 | 1 |
| Example 1e | 0 | 5 | 6 | 2 | 1 |
| Example 1f | 1 | 4 | 8 | 2 | 1 |
| Example 1g | 1 | 7 | 4 | 2 | 2 |
| Example 1h | 12 | 14 | 9 | 2 | 2 |
| Example 1i | | | filter | 4 | 4 |
| | | | blocked | | |
| Example 2 | 512 | 551 | 22 | 2 | 2 |
| Example 3 | 426 | 412 | 15 | 2 | 2 |
| Example 4 | 124 | 113 | 12 | 1 | 1 |
| Example 4a | 249 | 273 | 14 | 1 | 1 |
| Example 4b | 169 | 156 | 13 | 1 | 1 |
| Example 4c | 12 | 19 | 6 | 1 | 1 |
| Example 4d | 0 | 1 | 5 | 2 | 2 |
| Example 4e | 0 | 1 | 4 | 2 | 2 |
| Example 4f | 12 | 14 | 7 | 2 | 2 |
| Example 5a | 55 | 52 | 5 | 1 | 1 |
| Example 5b | 19 | 23 | 6 | 2 | 2 |

^{#}after a time period of three weeks at RT
Laropal ® is a registered trademark of BASF AG, Solsperse ® is a registered
trademark of Lubrizol ® Corporation, and Synthetic Resin TC ® is a registered
trademark of Evonik Industries.

### Application Examples

The pigment preparations produced in examples 1-6, apart from example 1i, were employed as colorants in a display functioning according to the electrowetting principle, in analogy to WO 2005098524. The display shows very short switching times for the driving of the pixels, and a high contrast value in tandem with brilliant color.

1. A colorant for generating a colored optical image in an electronic display, wherein the colorant includes a pigment preparation comprising
(A) at least one organic pigment, inorganic pigment or a mixture thereof,
(B) at least one solvent-soluble or solvent-dispersible polymeric dispersant,
(C) at least one aldehyde resin or ketone resin,
(D) optionally, other adjuvants customary for producing solvent-containing pigment preparations, and
(E) at least one hydrophobic solvent.

2. The colorant as claimed in claim 1, wherein the colorant is for a display, and wherein the display operates by electrowetting.

3. An electrophoretically operating display comprising a colorant as claimed in claim 1.

4. The use colorant as claimed in claim 1, wherein the pigment preparation contains
(A) 0.1% to 80% by weight of the at least one organic pigment, inorganic pigment or mixture thereof,
(B) 0.1% to 30% by weight of the at least one solvent-soluble or solvent-dispersible polymeric dispersant,
(C) 0.1% to 80% by weight of the aldehyde resin or ketone resin,
(D) 0% to 50% by weight of the further adjuvants customary for producing solvent-containing pigment preparations, and
(E) 5% to 99% by weight of the at least one hydrophobic solvent, based in each case on the total weight of the pigment preparation.

5. The use colorant as claimed in claim 1, wherein the organic pigment is selected from the group consisting of the monoazo, disazo, laked azo, β-naphthol, naphthol AS, benzimidazolone, disazo condensation, azo metal complex pigments, carbon blacks and the polycyclic pigments, wherein the polycyclic pigments are selected from the group consisting of phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline, and diketopyrrolopyrrole pigments.

6. The colorant as claimed in one or more of claims 1, wherein the at least one hydrophobic solvent (E) has a Reichardt number E_{T}(30) of more than 27 kcal/mol and less than 50 kcal/mol.

7. The use colorant as claimed in claim 1, wherein the at least hydrophobic solvent (E) is decane, decalin or tetralin or a mixture thereof or comprises as a main constituent decane, decalin or tetralin or a mixture thereof.

8. A pigment preparation containing
(A) 0.1% to 80% by weight of at least one organic pigment, inorganic pigment or a mixture thereof,
(B) 0.1% to 30% by weight of at least one solvent-soluble or solvent-dispersible polymeric dispersant,
(C) 0.1% to 80% by weight of an aldehyde resin or ketone resin,
(D) 0% to 50% by weight of further additives customary for producing solvent-containing pigment preparations, and
(E) 5% to 99% by weight of decane, tetralin, decalin or a mixture thereof, based in each case on the total weight of the pigment preparation.

9. The pigment preparation as claimed in claim 8, wherein component (C) is a condensation product of urea with an aliphatic aldehyde, or a condensation product of an aliphatic aldehyde with a ketone.
